(19) United States
(12) Patent Application Publication
(10) Pub. No.: US 2024/0175500 A1
(43) Pub. Date: May 30, 2024

(54) WATER CONTROL VALVE

(71) Applicant: Hsiang-Shih Wang, Changhua (TW)

(72) Inventor: Hsiang-Shih Wang, Changhua (TW)

(73) Assignee: GEANN INDUSTRIAL CO.,LTD., CHANGHUA (TW)

(21) Appl. No.: 18/072,597

(22) Filed: Nov. 30, 2022

(51) Int. Cl. F16K 11/02; F16L 41/02

(52) U.S. Cl. CPC F16K 11/025; F16L 41/021

(57) ABSTRACT

A water control valve may include a three-way pipe, an inner tube, an outer threaded tube, and a control valve. The three-way pipe integrally formed in T-shape has a water inlet end and a first connecting end which are longitudinally communicated, and a water outlet end communicated with the water inlet end and first connecting end is extended toward the lateral direction, to form the T-shape pipe. A small section's diameter is smaller than the water inlet end, and the bottom portion of the small section comprises an abutting portion, and a first water inlet hole axially penetrates through the abutting portion. One end of the inner tube is top-down inserted through the first connecting end into the small section of the three-way pipe, and a water stop periphery having a diameter larger than the inner tube is formed at the other end of the inner tube.

### FIELD OF THE INVENTION

The present invention relates to a water control valve and more particularly to a water control valve that is easy to assemble.

### BACKGROUND OF THE INVENTION

Referring to FIGS. 7 and 8, a conventional water control valve (50) comprises a connecting base (51), an inner tube (52), an outer threaded tube (53), and a control valve (54). The connecting base (51) has a through hole (511) axially penetrating through the connecting base (51), and two ends of the connecting base (51) respectively have inner threaded sections (512) on the inner peripheries thereof. A screw hole penetrates through a lateral side of the connecting base (51) to communicate with the through hole (511), and a water outlet hole (513) is connected to a water outlet tube (513). The inner tube (52) has a water inlet end (521) at an end thereof, and the water inlet end (521) has an outer threaded section (522) so as to connect on one end of the through hole (511). Moreover, a blocking periphery (523) is formed between the water inlet end (521) and the outer threaded section (522) on one end of the inner tube (52), and a water stop periphery (524) extends from the other end of the inner tube (52). One end of the outer threaded tube (53) is connected to the end of the through hole (511) other than the water inlet end (521), and water channel (531) is formed between inner tube (52) and the outer threaded tube (53). The control valve (54) is connected to the end of the outer threaded tube (53) other than the water inlet end (51). The outer threaded tube (53) is connected to the connecting base (51) and the control valve (54) at two ends thereof, and the water stop periphery (524) is abutted against the water inlet water of the control valve (54), so as to complete the structure of the water control valve.

However, the water control valve has following disadvantages: (i) the inner tube penetrates through the connecting base (51) and connects to the connecting base (51) through threaded sections (512)(522), and the water inlet end (521) protrudes out from the connecting base (51), so that the length of the inner tube (52) inserting into the outer threaded tube (53) is limited and the water stop periphery (524) of the inner tube (52) cannot be pressed against the control valve (54); as a result, when water is closed, the water control valve will leak due to water flow pressure, and also the water control valve is usually hidden in the outlet equipment, which make it difficult to replace, resulting in the use of inconvenience; (ii) the two ends of the inner tube (52) respectively has the water inlet end (521) and the water stop periphery (524), and since the length of the inner tube (52) cannot be modified according to the actual condition, it will consume labor and manufacturing costs during assembling process. Therefore, there remains a need for a new and improved design for a water control valve to overcome the problems presented above.

### SUMMARY OF THE INVENTION

The present invention provides a water control valve comprising a three-way pipe, an inner tube, an outer threaded tube, and a control valve. The three-way pipe integrally formed in T-shape has a water inlet end and a first connecting end which are longitudinally communicated, and a water outlet end communicated with the water inlet end and the first connecting end is extended toward the lateral direction, so as to form the T-shape pipe. A small section formed below the water outlet end and adjacent to the water inlet end has a diameter smaller than the water inlet end, and the bottom portion of the small section comprises an abutting portion, and a first water inlet hole axially penetrates through the abutting portion. One end of the inner tube is top-down inserted through the first connecting end and connected into the small section of the three-way pipe, and a water stop periphery having a diameter larger than the inner tube is formed at the other end of the inner tube. The outer threaded tube has one end screw-locked on the first connecting end of the three-way pipe. The outer threaded tube is located around the inner tube, and a water channel is formed between the outer threaded tube and the inner tube. The control valve is screw-locked on the end of the outer threaded tube other than the end screw-locked on the first connecting end, and the bottom portion of the control valve having a second water inlet hole is abutted against the top end of the water stop periphery. The control valve comprises at least a water outlet hole at the lateral side thereof, and the control valve is rotatable to control the conduction between the second water inlet hole and the water outlet hole. One end of the inner tube is inserted into and connected with the three-way pipe, and the outer threaded tube is connected between the three-way pipe and the control valve, so that the water stop periphery of the inner tube is firmly abutted against the bottom portion of the control valve.

In one embodiment, one end of the outer threaded tube is screw-locked on the first connecting end of the three-way pipe while the other end of the outer threaded tube is screw-locked on the control valve.

In another embodiment, the inner tube has a second connecting end at one end thereof, and at least a peripheral groove is formed on the outer periphery of the second connecting end to couple with at least an O-ring thereon, and the second connecting end is adapted to firmly couple in the small section of the three-way pipe.

In still another embodiment, the length of the second connecting end of the inner tube and the length of the end of the outer threaded tube are adjusted by cut according to the actual need, so as to improve the tightness between the water stop periphery of the inner tube and the control valve.

Comparing with conventional water control valve, the present invention is advantageous because: (i) the second connecting end of the inner tube is inserted into and connected to the small section of the three-way pipe so as to secure one end of the inner tube, and the outer threaded tube is connected to the control valve and the three-way pipe, so that when the outer threaded tube is screw-locked with the control valve, the water stop periphery of the inner tube is adapted to gradually abut against the bottom portion of the control valve so as to ensure the tightness between the inner tube and the control valve and to prevent the leakage; and (ii) the length of the outer threaded tube is adjusted by cut to cooperate the length of the inner tube, such that the length of the water control valve is shortened when the outer threaded tube is connected between the three-way pipe and the control valve, so as to improve the flexibility and convenience of structural assembly.

### BRIEF DESCRIPTION OF THE DRAWINGS

FIG. 1 is a three-dimensional assembly view of a water control valve of the present invention.

FIG. 2 is a three-dimensional exploded view of the water control valve of the present invention.

FIG. 3 is a sectional assembly view of the water control valve of the present invention.

FIG. 4 is an exploded view illustrating the lengths of an inner tube and outer threaded tube of the water control valve are adjusted by cut in the present invention.

FIG. 5 is a sectional assembly view illustrating the water control valve of the present invention when the inner tube and the outer threaded tube are adjusted by cut.

FIG. 6 is a schematic view of the water control valve of the present invention when in actual use.

FIG. 7 is a prior art.

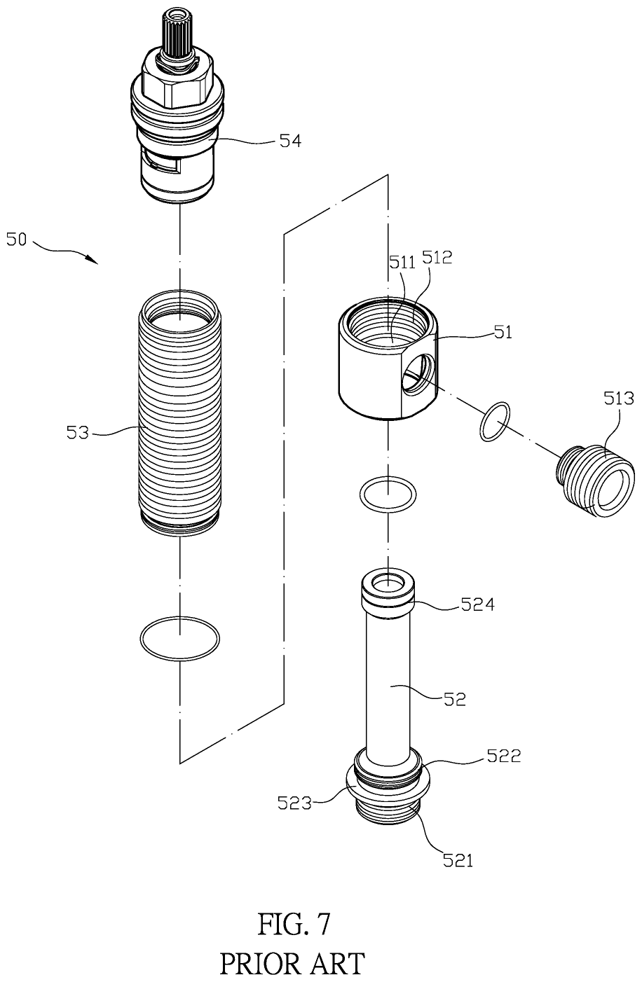

FIG. 8 is a prior art.

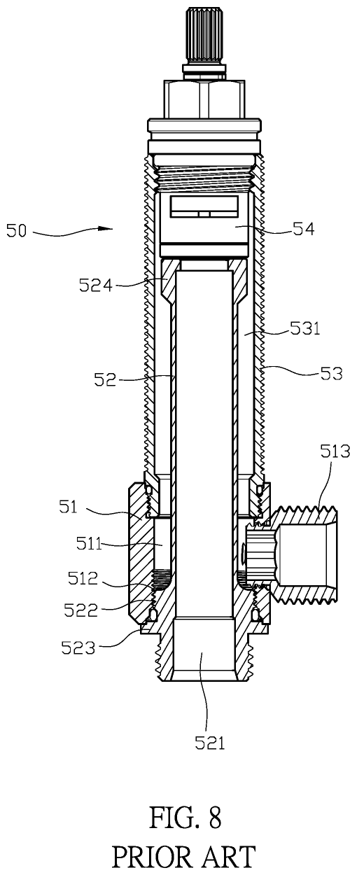

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

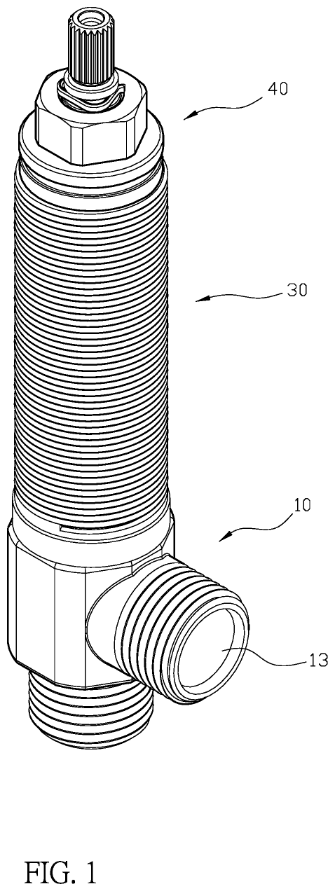

Referring to FIGS. 1 to 3, the present invention provides a water control valve comprising a three-way pipe (10), an inner tube (20), an outer threaded tube (30), and a control valve (40). The three-way pipe (10) integrally formed in T-shape has a water inlet end (11) and a first connecting end (12) which are longitudinally communicated, and a water outlet end (13) communicated with the water inlet end (11) and the first connecting end (12) is extended toward the lateral direction, so as to form the T-shape pipe (10). A small section (14) formed below the water outlet end (13) and adjacent to the water inlet end (11) has a diameter smaller than the water inlet end (11), and the bottom portion of the small section (14) comprises an abutting portion (141), and a first water inlet hole (142) axially penetrates through the abutting portion (141). The inner tube (20) has a second connecting end (21) at an end thereof, and at least a peripheral groove (211) is formed on the outer periphery of the second connecting end (21) to couple with at least an O-ring (212) thereon. The second connecting end (21) is top-down inserted through the first connecting end (12) and connected into the small section (14) of the three-way pipe (10), and a water stop periphery (22) having a diameter larger than the inner tube (20) is formed at the end of the inner tube (20) other than the second connecting end (21). The outer threaded tube (30) has one end screw-locked on the first connecting end (12) of the three-way pipe (10). The outer threaded tube (30) is located around the inner tube (20), and a water channel (31) is formed between the outer threaded tube (30) and the inner tube (20). The control valve (40) is screw-locked on the end of the outer threaded tube (30) other than the end screw-locked on the first connecting end (12), and the bottom portion of the control valve (40) having a second water inlet hole (41) is abutted against the top end of the water stop periphery (22). Also, the control valve (40) comprises at least a water outlet hole (42) at the lateral side thereof, and the control valve (40) is rotatable to control the conduction between the second water inlet hole (41) and the water outlet hole (42).

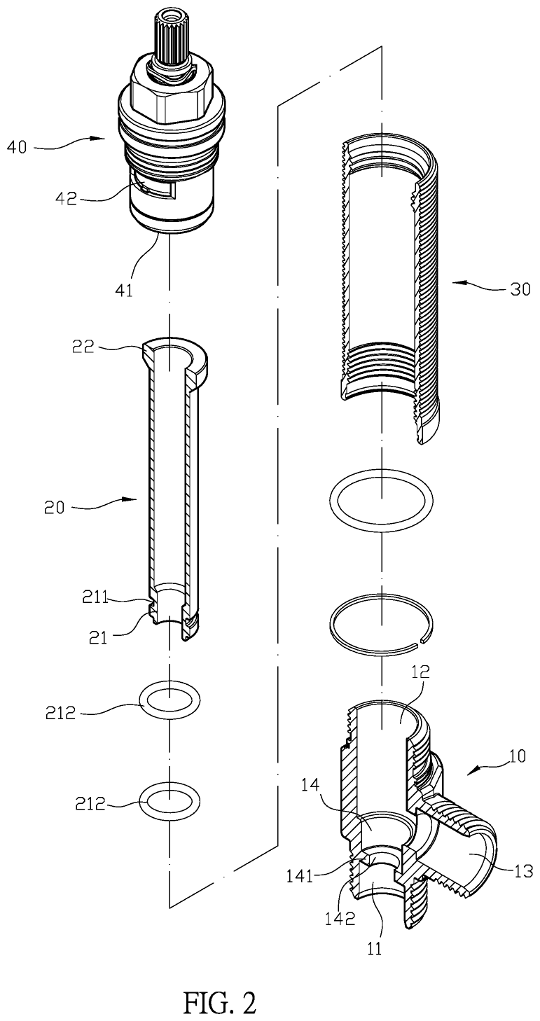

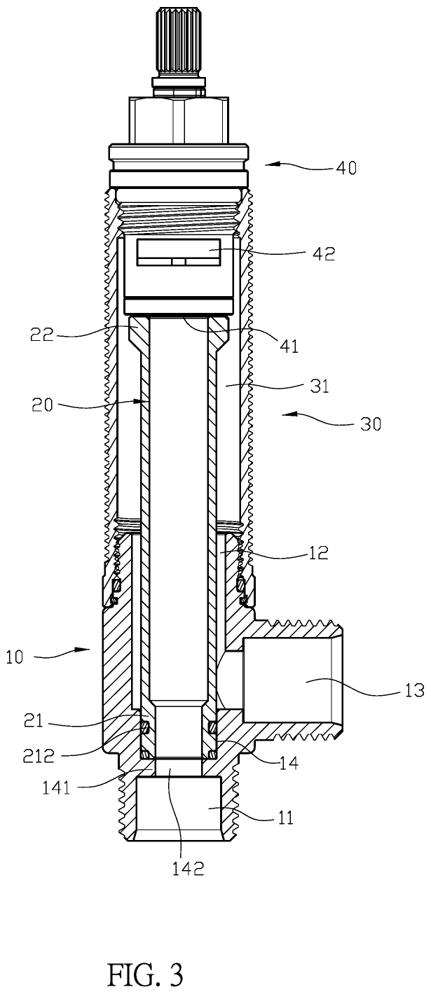

Referring to FIGS. 2 and 3, the second connecting end (21) of the inner tube (20) is adapted to pass through the first connecting end (12) and connect with the small section (14), and the second connecting end (21) is firmly coupled with the small section (14) through the O-ring so as to secure the end of the inner tube (20) in the three-way pipe (10). One end of the outer threaded tube (30) is screw-locked on the first connecting end (12) of the three-way pipe (10), and the other end of the outer threaded tube (30) is screw-locked with the control valve (40). Thus, when the outer threaded tube (30) is screw-locked with the control valve (40), the water stop periphery (22) of the inner tube (20) is adapted to gradually abut against the bottom portion of the control valve (40) so as to ensure the tightness between the inner tube (20) and the control valve (40) and prevent the leakage.

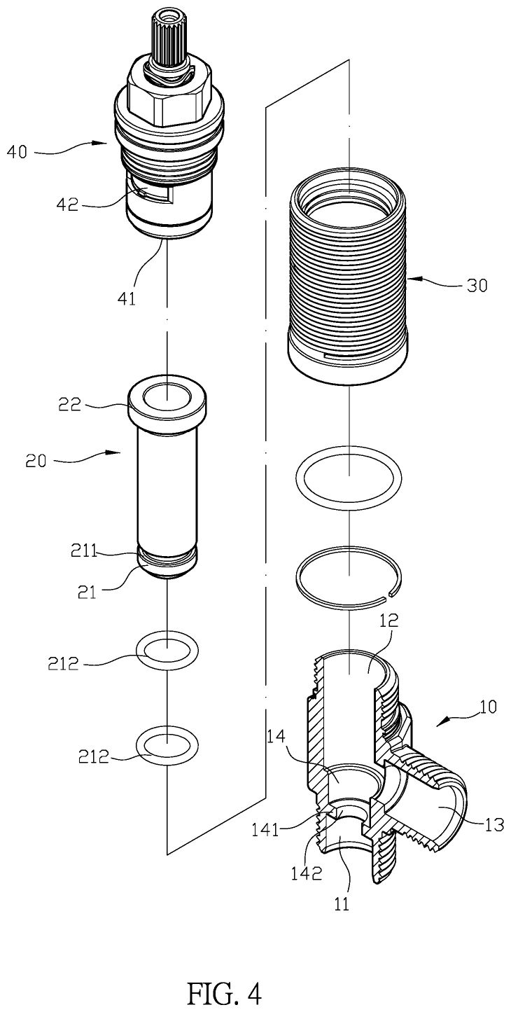

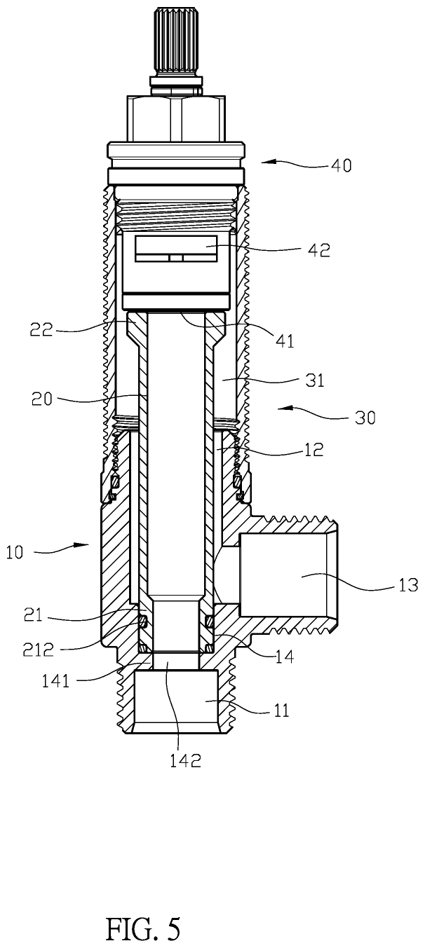

Moreover, during assembling process, the second connecting end (21) of the inner tube (20) is inserted and connected in the three-way pipe (10) first, the length of the inner pipe (20) is configured to be modified and cut according to field assembly space and demand, and the peripheral groove (211) on the outer periphery of the inner tube (20) can be designed and formed after the inner tube (20) is cut, and the O-ring (212) is disposed on the peripheral groove (211) so as to enable the second connecting end (21) to be secured in the small section (14). The length of the outer threaded tube (30) is adjusted by cut to cooperate the length of the inner tube (20), such that as shown in FIGS. 4 and 5, the length of the water control valve is shortened when the outer threaded tube is connected between the three-way pipe (10) and the control valve (40), so as to improve the flexibility and convenience of structural assembly.

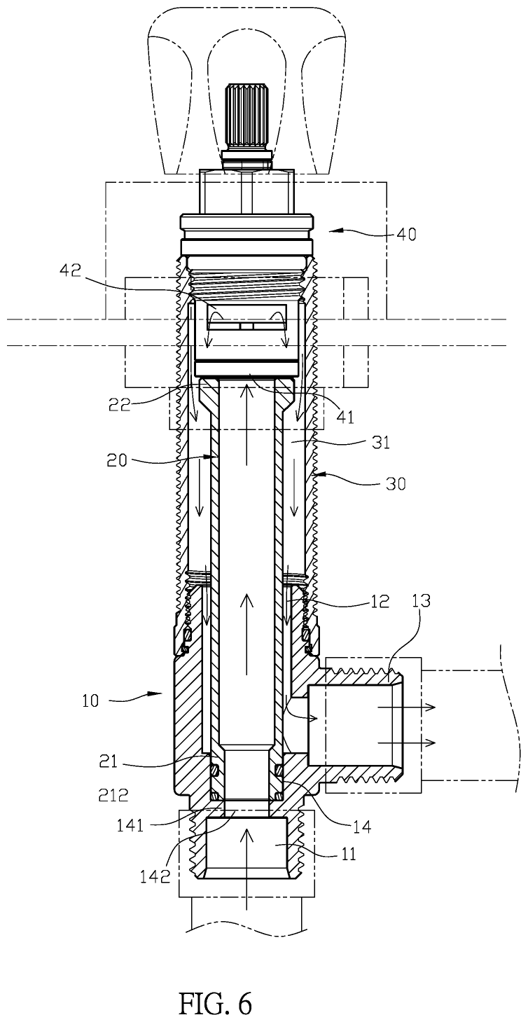

Structurally, referring to FIG. 6, the water control valve is hidden and assembled under the countertop, wood decoration, or stone plastic water equipment. The water inlet end (11) of the three-way pipe (10) is connected to the water source on the wall surface while the water outlet end (13) is connected to the water outlet tube of the faucet (not shown in FIGs.), and the control valve (40) is adapted to protrude out from the countertop for operation by the user. When the control valve is not rotated and at the closed position, the interior valve pieces of the control valve (40) are misaligned, and the second water inlet hole (41) is not communicated with the water outlet hole (42), so that the water flow into the inner tube (20) is blocked to form a closed water state. On the contrary, when the control valve (40) is rotated, the interior valve pieces of the control valve (40) are aligned, and the water flowing through the inner tube (20) is configured to flow into the second water inlet hole (41) of the control valve (40) and to be discharged from the water outlet hole (42) on the lateral side of the control valve (40). Thus, the water flowing into the water channel (31) between the inner tube (20) and the outer threaded tube (30) is configured to flow out from the water outlet end (13) of the three-way pipe (10) for use.

Comparing with conventional water control valve, the present invention is advantageous because: (i) the second connecting end (21) of the inner tube (20) is inserted into and connected to the small section (14) of the three-way pipe so as to secure one end of the inner tube (20), and the outer threaded tube (30) is connected to the control valve (40) and the three-way pipe (10), so that when the outer threaded tube (30) is screw-locked with the control valve (40), the water stop periphery (22) of the inner tube (20) is adapted to gradually abut against the bottom portion of the control valve (40) so as to ensure the tightness between the inner tube (20) and the control valve (40) and prevent the leakage; and (ii) the length of the outer threaded tube (30) is adjusted by cut to cooperate the length of the inner tube (20), such that the length of the water control valve is shortened when the outer threaded tube is connected between the three-way pipe (10) and the control valve (40), so as to improve the flexibility and convenience of structural assembly.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A water control valve comprising a three-way pipe, an inner tube, an outer threaded tube, and a control valve;
wherein the three-way pipe integrally formed in T-shape has a water inlet end and a first connecting end which are longitudinally communicated, and a water outlet end communicated with the water inlet end and the first connecting end is extended toward the lateral direction, so as to form the T-shape pipe; a small section formed below the water outlet end and adjacent to the water inlet end has a diameter smaller than the water inlet end, and the bottom portion of the small section comprises an abutting portion, and a first water inlet hole axially penetrates through the abutting portion; one end of the inner tube is top-down inserted through the first connecting end and connected into the small section of the three-way pipe, and a water stop periphery having a diameter larger than the inner tube is formed at the other end of the inner tube; the outer threaded tube having one end screw-locked on the first connecting end of the three-way pipe is located around the inner tube, and a water channel is formed between the outer threaded tube and the inner tube; the control valve is screw-locked on the other end of the outer threaded tube, and the bottom portion of the control valve having a second water inlet hole is abutted against the top end of the water stop periphery; the control valve comprises at least a water outlet hole at the lateral side thereof, and the control valve is rotatable to control the conduction between the second water inlet hole and the water outlet hole; one end of the inner tube is inserted into and connected with the three-way pipe, and the outer threaded tube is connected between the three-way pipe and the control valve, so that the water stop periphery of the inner tube is firmly abutted against the bottom portion of the control valve.

2. The water control valve of claim 1, wherein one end of the outer threaded tube is screw-locked on the first connecting end of the three-way pipe while the other end of the outer threaded tube is screw-locked on the control valve.

3. The water control valve of claim 1, wherein the inner tube has a second connecting end at one end thereof, and at least a peripheral groove is formed on the outer periphery of the second connecting end to couple with at least an O-ring thereon, and the second connecting end is adapted to firmly couple in the small section of the three-way pipe.

4. The water control valve of claim 1, wherein the length of the second connecting end of the inner tube and the length of the end of the outer threaded tube are adjusted by cut according to the actual need, so as to improve the tightness between the water stop periphery of the inner tube and the control valve.
